(19) United States
(12) Patent Application Publication
(10) Pub. No.: US 2007/0275574 A1
(43) Pub. Date: Nov. 29, 2007

(54) Chip Assembly Structure With Cover

(75) Inventor: Jeffrey Lien, Taipei City (TW)

Correspondence Address: OPTIMUM CARE INTERNATIONAL TECH, INC., 8F, NO. 28, LANE 513, RUEI GUANG ROAD, TAIPEI, 114, TW

(73) Assignee: Optimum Care International Tech. Inc., Taipei City (TW)

(21) Appl. No.: 11/836,126

(22) Filed: Aug. 8, 2007

Related U.S. Application Data
(63) Continuation of application No. 10/959,168, filed on Oct. 7, 2004.

(51) Int. Cl. H01R 12/02

(52) U.S. Cl. 439/73

(57) ABSTRACT

The present invention provides a chip assembly structure with a cover, comprising: a socket having four sidewalls to form a room for placing a chip and comprising a plurality of contact ends corresponding to the contacts of the chip to be placed, wherein each contact ends penetrates said socket to form an exposing solder terminal; and a cover having at least a flexible part against on the chip when the chip is positioned in the room.

The present application is a continue-in-part application of the application filed previously on Oct. 7, 2004, application Ser. No. 10/959,168, “chip assembly structure and socket”.

### BACKGROUND OF THE PRESENT INVENTION

1. Field of Invention

The present invention relates to a chip assembly structure, more particularly to a chip assembly structure with a cover.

2. Description of Related Arts

Referring to FIG. 1, a chip assembly structure includes a chip 1 having multiple contacts 11 in multiple rows, for example, two rows, on its bottom surface, and a socket 2 having a concave on its one side for accommodating the chip 1 and multiple contact ends 21 corresponding to the multiple contacts 11, wherein each contact end 21 penetrates the socket and extends out from it (referring to FIG. 2) to form a exposing solder terminal 222. Conventionally, the chip 1 is fixed on the socket 2 by soldering the contacts 11 and contact ends 21. There still needs a chip assembly structure for further securing the chip 1 on the socket without soldering or clipping by clipper.

### SUMMARY OF THE PRESENT INVENTION

The object of the present invention is to provide a chip assembly structure capable of securing a chip in a socket without soldering.

Another objective of the present invention is to provide a chip assembly structure capable of securing a chip in a socket more easily replaceable if there is a defect in the chip.

In order to achieve mentioned objectives, the present invention provides a chip assembly structure with a cover, which comprises: a socket having four sidewalls to form a room for placing a chip and comprising a plurality of contact ends corresponding to the contacts of the chip to be placed, wherein each contact ends penetrates the socket to form an exposing solder terminal; and a cover comprising at least a flexible part against on the chip when the chip is positioned in the room.

In the chip assembly structure with a cover of the present invention, the socket further comprises a fixing part and the cover comprises a counter part so that the cover is fixed on the socket by the engagement of the fixing part and the counter part. In the present invention, the counterpart means that the part is in the shape which can be associated and engaged with the fixing part. Therefore, the shape of the counterpart is determined depending on the shape of the fixing part and shapes of the fixing part and counterpart are not limited as long as the both parts can be fixed together by engagement with each other.

In the chip assembly structure with a cover of the present invention, one end of said cover is physically connected to said socket.

In the chip assembly structure with a cover of the present invention, the cover comprises a vertically extending part at the end opposing to the connecting part and said sidewalls of the socket corresponding to the extending part is provided with a slit trench for accommodating the extending part.

In the chip assembly structure with a cover of the present invention, the cover is removable from said socket completely and comprises at least two sidewalls on which a counter part is provided.

In the chip assembly structure with a cover of the present invention, the upper end of the slit trench is provided with a guiding angle for guiding the extending part inserting into the slit trench.

In the chip assembly structure with a cover of the present invention, the contact ends provided in the socket penetrate the socket and extend out from the socket to form an extending lead for electrically connecting with circuit board.

Alternatively, the contact ends provided in the socket penetrate the socket and expose on the bottom surface of the socket to electrically connect with circuit board.

These and other features and advantages of the present invention will become readily apparent to those skilled in this art from the following description by reference to preferred embodiments of the present invention. As it will be realized, various modifications and change can be made without departing from the spirit and scope of the present invention. Such drawings and descriptions are used only for illustrating the present invention without limiting its scope.

### BRIEF DESCRIPTION OF THE DRAWINGS

FIG. 1 shows schematic view of a prior art of a chip assembly structure.

FIG. 2 shows a cross-section view of a contact end in the chip assembly structure shown in FIG. 1.

FIG. 3 shows a cross-section view of the first embodiment of the present chip assembly structure with a cover.

FIG. 4 shows a cross-section view of the second embodiment of the present chip assembly structure with a cover.

FIG. 5 shows a cross-section view of the third embodiment of the present chip assembly structure with a cover wherein the cover has not yet fixed on the socket.

FIG. 6 shows a cross-section view of the fourth embodiment of the present chip assembly structure with a cover wherein the cover fixes on the socket.

FIG. 7 shows an exploded view of the chip assembly structure shown in FIG. 3.

FIG. 8 shows an exploded view of the chip assembly structure shown in FIG. 5.

FIG. 9 shows a cross-section view of the fifth embodiment of the present chip assembly structure with a cover.

FIG. 10 shows a cross-section view of the sixth embodiment of the present chip assembly structure with a cover.

FIG. 11 shows an exploded view of the seventh embodiment of the present chip assembly structure with a cover.

FIG. 12 shows a cross-section view of an alternative embodiment of the contact end in socket of the chip assembly structure of the present invention.

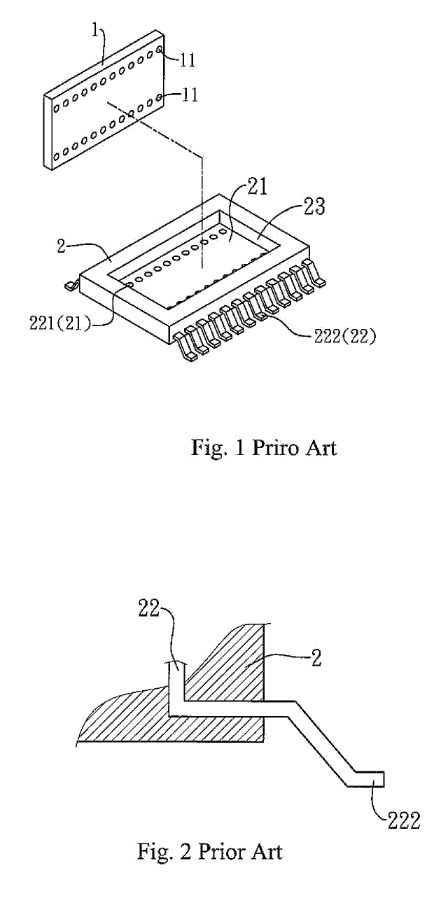

### DETAILED DESCRIPTION OF THE PREFERRED EMBODIMENTS

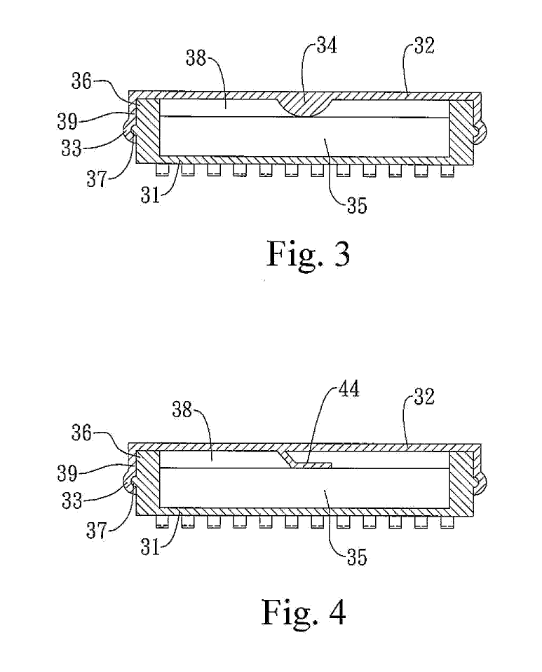

FIG. 3 shows a cross-section view of the first embodiment of the present chip assembly structure with a cover. As shown in FIG. 3, the chip assembly structure with a cover according to the present invention includes a socket 31 having four sidewalls 36 to form a room 38 for placing a chip 35 and a cover 32 having at least two sidewalls 39 and a flexible part 34 on its lower surface for against the chip 35. On an outer surface of at least two sidewalls 36 is provided with a bulging part 37 (fixing part) and on the inner surface of the sidewalls 39 is provided with a sunk part 33 (the counter part) for engaging with the bulging part 37. By using the flexible part 34 against the chip 35, the chip 35 can be secured in the socket in its position. The material of the flexible part 34 may be made from metal or plastic material as long as it exhibits flexibility. In this embodiment, the flexible part 34 is in the form of a convexity.

FIG. 4 shows a cross-section view of the second embodiment of the present chip assembly structure with a cover. The chip assembly structure with a cover shown in FIG. 4 is similar to FIG. 3 but the difference between them is that the flexible part 44 of the chip assembly structure of FIG. 4 is in the form of a bending plate.

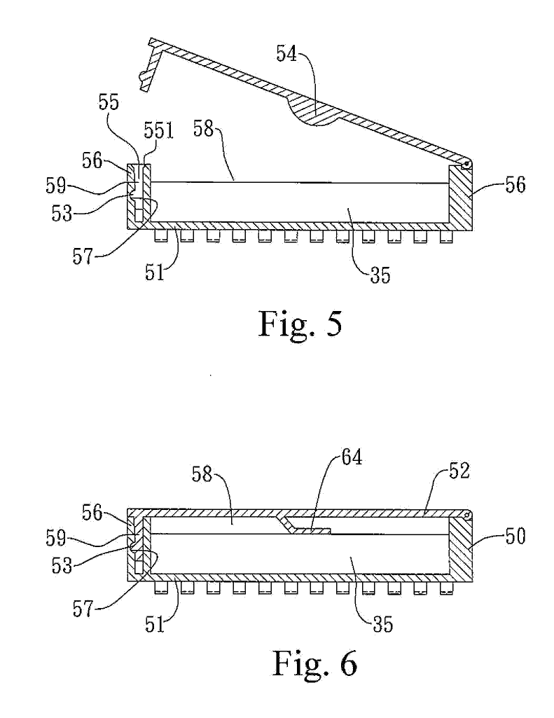

FIG. 5 shows a cross-section view of the third embodiment of the present chip assembly structure with a cover wherein the cover has not yet fixed on the socket. As shown in FIG. 5, the chip assembly structure with a cover of the present invention includes a socket 51 and a cover 52. The socket 51 is similar to the socket 2 shown in FIG. 1 and comprises four sidewalls 56 to form a room 58 for placing the chip 35. The cover 52 is connected to one of the sidewalls 56 and comprises a vertically extending part 59 at the end opposing to the connecting part and a flexible part 54 on its lower surface in a convex shape to press the chip 35 for securing the chip 35 in its position. The sidewalls 56 corresponding to the extending part 59 is provided with a slit trench 55 for accommodating the extending part 59 and a sunk part 57 is provided in the slit trench 55. The vertically extending part 59 is provided with a bulging part 53 for engaging with the sunk part 57 when the vertically extending part 59 is inserted into the slit trench 55. The flexible part 54 may be made from a metal or plastic as long as it exhibits flexibility. For inserting the vertically extending part 59 into the slit trench 55 smoothly, the upper end of the slit trench 55 is provided with a guiding angle 551 and either the extending part 59 or the cover 52 is made from a metal or plastic to impart them with flexibility.

FIG. 6 shows a cross-section view of the fourth embodiment of the present chip assembly structure with a cover wherein the cover fixes on the socket. The chip assembly structure with a cover shown in FIG. 6 is similar to FIG. 5 but the difference between them is that the flexible part 64 of the chip assembly structure of FIG. 6 is in the form of a bending plate.

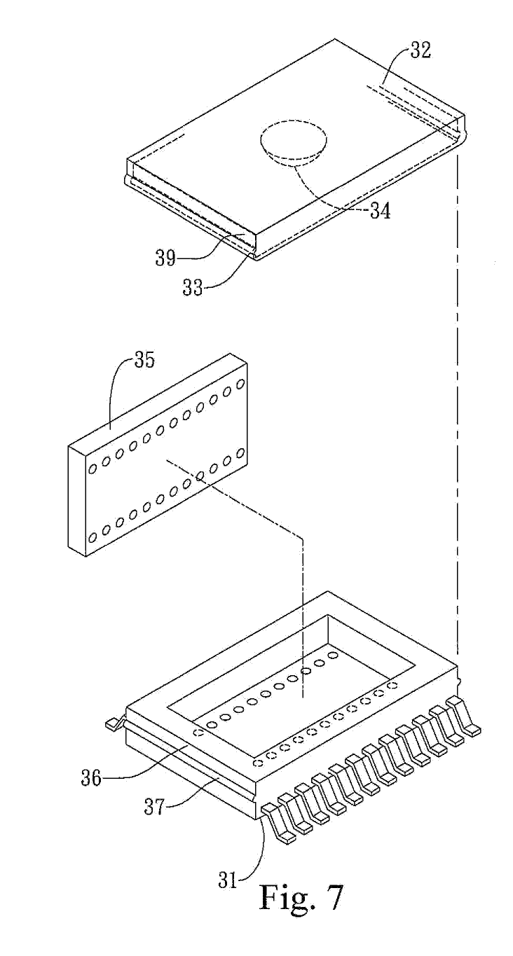

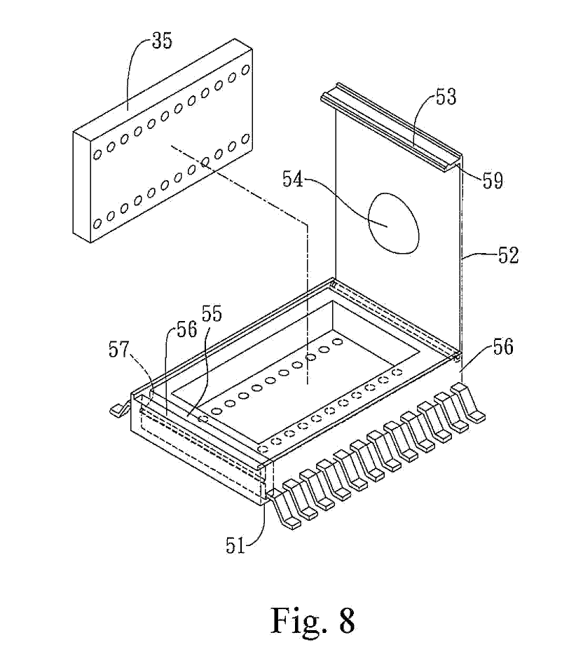

FIG. 7 shows an exploded view of the chip assembly structure shown in FIG. 3 and FIG. 8 shows an exploded view of the chip assembly structure shown in FIG. 5.

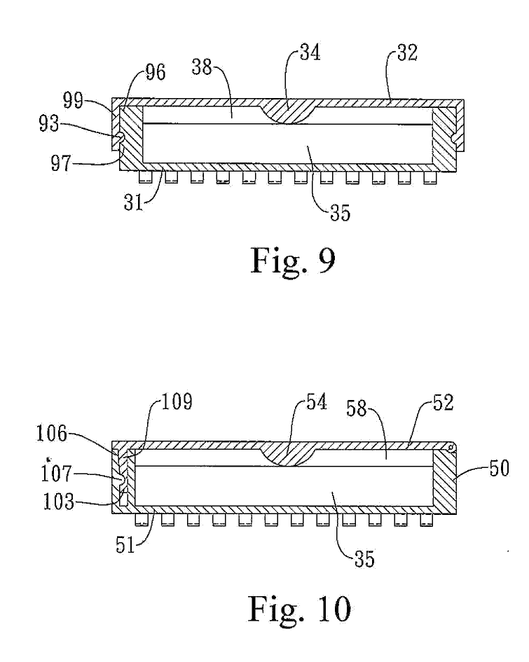

FIG. 9 shows a cross-section view of the fifth embodiment of the present chip assembly structure with a cover. The chip assembly structure with a cover shown in FIG. 9 is similar to FIG. 3 but the difference between them is that on an outer surface of at least two sidewalls 96 of the chip assembly structure of FIG. 9 is provided with a sunk part 97 and on the inner surface of the sidewalls 99 is provided with a bulging part 93 for engaging with the sunk part 97.

FIG. 10 shows a cross-section view of the sixth embodiment of the present chip assembly structure with a cover. The chip assembly structure with a cover shown in FIG. 10 is similar to FIG. 5 but the difference between them is that on an outer surface of the vertically extending part 109 of the chip assembly structure of FIG. 10 is provided with a sunk part 103 and in slit trench is provided with a bulging part 107 for engaging with the sunk part 103.

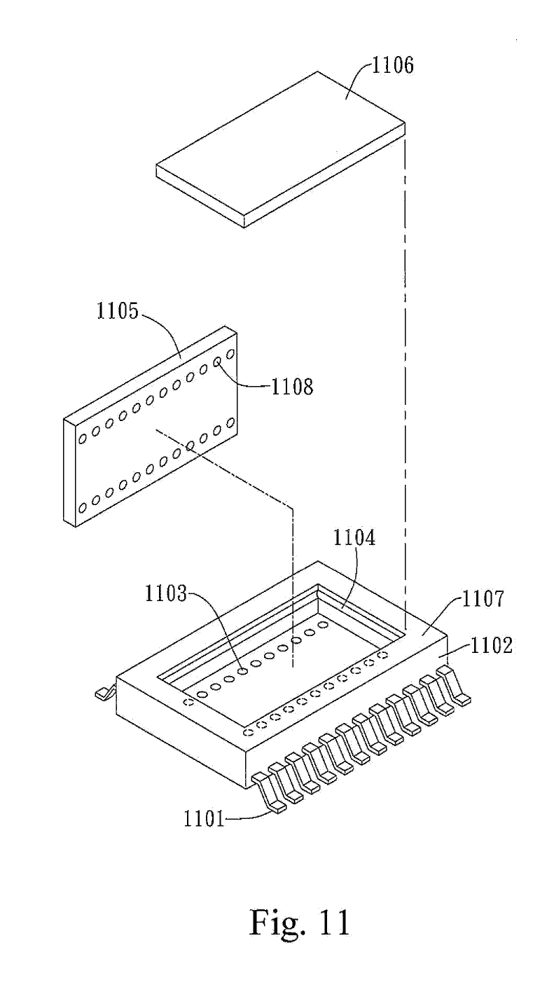

FIG. 11 shows an exploded view of the seventh embodiment of the present chip assembly structure with a cover. As shown in FIG. 11, the chip assembly structure with a cover according to the present invention includes a socket 1102 having four sidewalls 1107 to form a room for placing a chip 1105 and a cover 1106; wherein the inner wall of at least two sidewalls 1107 is provided with a bulging part 1104 for restricting the cover 1106 in its position when the cover 1106 is placed and pressed toward the room. The socket 1102 is provided with multiple contact ends 1103, which are extended from the socket 1102 to form an extending lead 1101 for electrically connecting with circuit board. Correspondingly, the chip 1105 is provided with a plurality of contacts 1108.

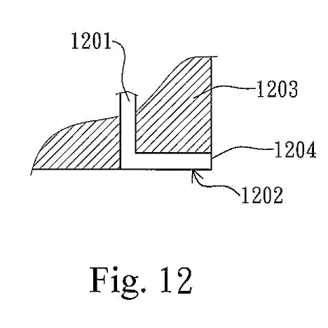

FIG. 12 shows a cross-section view of an alternative embodiment of the contact end in socket of the chip assembly structure of the present invention. As shown in FIG. 12, the contact ends 1201 provided in the socket 1203 penetrate the socket and expose on the bottom surface of the socket to form lead 1202 for electrically connecting with circuit board.

According to the chip assembly structure of the present invention, the chip can be secured in the socket without soldering or clipping by a clipper and the chip is easily replaceable if there is a defect on the chip.

Although the invention has been described and illustrated with reference to specific illustrative embodiments thereof, it is not intended that the invention be limited to those illustrative embodiments. Those skilled in the art will recognize that variations and modifications can be made without departing from the spirit of the present invention. It is therefore intended to include within the invention all such variations and modifications which fall within the scope of the appended claims and equivalents thereof.

What is claimed is:

1. A chip assembly structure with a cover comprising:
a socket having four sidewalls to form a room for placing a chip and comprising a plurality of contact ends corresponding to the contacts of the chip to be placed, wherein each contact ends penetrates the socket to form an exposing solder terminal; and
a cover having at least a flexible part against on the chip when the chip is positioned in the room.

2. The chip assembly structure in accordance with claim 1, wherein said socket further comprises a fixing part and the cover comprises a counter part so that the cover is fixed on the socket by the engagement of the fixing part and the counter part.

3. The chip assembly structure in accordance with claim 2, wherein one end of said cover is physically connected to said socket.

4. The chip assembly structure in accordance with claim 3, wherein said cover comprises a vertically extending part at the end opposing to the connecting part and said sidewalls of the socket corresponding to the extending part is provided with a slit trench for accommodating the extending part.

5. The chip assembly structure in accordance with claim 4, wherein the upper end of the slit trench is provided with a guiding angle.

6. The chip assembly structure in accordance with claim 1, wherein said cover is removable from said socket completely.

7. The chip assembly structure in accordance with claim 6, wherein said cover comprises at least two sidewalls on which a counter part is provided.

8. The chip assembly structure in accordance with claim 1, wherein said contact ends provided in the socket penetrate the socket and extend out from the socket to form an extending lead for electrically connecting with circuit board.

9. The chip assembly structure in accordance with claim 1, wherein said contact ends provided in the socket penetrate the socket and expose on the bottom surface of the socket to electrically connect with circuit board.
